(19) United States
(12) Patent Application Publication
(10) Pub. No.: US 2012/0078683 A1
(43) Pub. Date: Mar. 29, 2012

(54) METHOD AND APPARATUS FOR PROVIDING ADVICE TO SERVICE PROVIDER

(75) Inventors: Veena B. Mendiratta, Oak Brook, IL (US); Chitra Phadke, Basking Ridge, NJ (US); Huseyin Uzunalioglu, Millington, NJ (US)

(73) Assignee: Alcatel-Lucent USA Inc.

(21) Appl. No.: 13/076,904

(22) Filed: Mar. 31, 2011

Related U.S. Application Data
(60) Provisional application No. 61/387,151, filed on Sep. 28, 2010.

(51) Int. Cl. G06Q 10/00

(52) U.S. Cl. 705/7.29

(57) ABSTRACT

A method for providing advice to a service provider includes; a) accessing customer, network, and service data stored in disparate data sources, the data relating to services provided to customers by a service provider over a network infrastructure, a virtualization platform presenting the disparate data in a common logical view; b) processing the data in an analytics platform using a service advisor algorithm to form conclusions and predictions regarding management of customer churn and generate advice; and c) formulating results from the processing to enable the service provider to consider the data, conclusions, predictions, and advice in relation to reduction of customer churn. The service advisor algorithm may also be used for personalization of service provided to customers, targeted marketing of services to customers or non-customers, and management of the network infrastructure. An apparatus for providing advice to a service provider includes the virtualization and analytics platforms.

This application is based on and claims priority to U.S. Provisional Application No. 61/387,151, filed Sep. 28, 2010, which is incorporated herein by reference in its entirety.

### BACKGROUND

This disclosure relates to a data technique, and more particularly, to a technique for processing service provider data to provide service advice to a service provider. For example, the disclosure describes exemplary embodiment of a method and apparatus for providing advice to a service provider that includes accessing customer, network, and service data from disparate data sources, processing the data for to generate advice for the service provider to consider in relation to reduction of customer churn. However, various embodiments of the methods and apparatus described herein may be used in conjunction with providing advice to the service provider for other purposes, such as improvement of personalized services, improvement of targeted marketing, or improvement of network infrastructure capabilities.

People may utilize many communications services in their daily life. These services include, for example, wireline and wireless telephone services, voice over IP (VoIP) services, cable TV services, satellite TV services, Internet protocol TV (IPTV) services, broadband and wireless data services, etc., which may be offered by service providers individually or as bundled services. Single point solutions for a specific purpose are the existing solutions and hence not amenable to expansion easily.

For these and other reasons, there is a need to provide a solution to providing advice to service providers that is robust, scalable, and expandable to accommodate service providers that offer diverse services across various types of networks using a variety of technological solutions.

### SUMMARY

In one aspect, a method for providing advice to a service provider is provided. In one embodiment, the method includes: a) accessing customer data, network data, and service data stored in a plurality of disparate data sources, wherein the customer data, network data, and service data relates to a plurality of services provided to a plurality of customers by a service provider over a network infrastructure, wherein a virtualization platform is used to present the customer data, network data, and service data from the disparate data sources in a common logical view; b) processing the customer data, network data, and service data in an analytics platform using a service advisor algorithm to form conclusions and predictions regarding personalization of service provided to customers, management of customer churn, targeted marketing of services to customers or non-customers, and management of the network infrastructure, wherein the service advisor algorithm is also used to generate advice for the service provider based at least in part on the customer data, network data, service data, conclusions, and predictions; and c) formulating results from the processing to enable the service provider to consider select aspects of the customer data, network data, service data, conclusions, predictions, and advice in relation to taking further action regarding improvement of personalized services, reduction of customer churn, improvement of targeted marketing, or improvement of network infrastructure capabilities.

In another embodiment, a method for providing advice to a service provider includes: a) accessing customer data, network data, and service data stored in a plurality of disparate data sources, wherein the customer data, network data, and service data relates to a plurality of services provided to a plurality of customers by a service provider over a network infrastructure, wherein a virtualization platform is used to present the customer data, network data, and service data from the disparate data sources in a common logical view; b) processing the customer data, network data, and service data in an analytics platform using a service advisor algorithm to form conclusions and predictions regarding management of customer churn, wherein the service advisor algorithm is also used to generate advice for the service provider based at least in part on the customer data, network data, service data, conclusions, and predictions; and c) formulating results from the processing to enable the service provider to consider select aspects of the customer data, network data, service data, conclusions, predictions, and advice in relation to reduction of customer churn.

In another aspect, an apparatus for providing advice to a service provider is provided. In one embodiment, the apparatus includes: a virtualization platform for accessing customer data, network data, and service data stored in a plurality of disparate data sources, wherein the customer data, network data, and service data relates to a plurality of services provided to a plurality of customers by a service provider over a network infrastructure, wherein the virtualization platform is also for presenting the customer data, network data, and service data from the disparate data sources in a common logical view; and an analytics platform in operative communication with the virtualization platform for processing the customer data, network data, and service data using a service advisor algorithm to form conclusions and predictions regarding personalization of service provided to customers, management of customer churn, targeted marketing of services to customers or non-customers, and management of the network infrastructure, wherein the service advisor algorithm is also used to generate advice for the service provider based at least in part on the customer data, network data, service data, conclusions, and predictions. In this embodiment, the analytics platform is also for formulating results from the processing to enable the service provider to consider select aspects of the customer data, network data, service data, conclusions, predictions, and advice in relation to taking further action regarding improvement of personalized services, reduction of customer churn, improvement of targeted marketing, or improvement of network infrastructure capabilities.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a diagram showing examples of customer data (e.g., subscriber data), network data, and service data that is available to an exemplary embodiment of a service advisor system;

FIG. 2 is a block diagram of an exemplary embodiment of a service advisor system;

FIG. 3 is a diagram showing examples of data, conclusions, predictions, and advice provided to a service provider by an exemplary embodiment of a service advisor system;

FIG. 4 is a block diagram of another exemplary embodiment of a service advisor system;

FIG. 5 is a flow chart of an exemplary embodiment of a process for providing advice to a service provider;

FIG. 6 is a flow chart of another exemplary embodiment of a process for providing advice to a service provider; and

FIG. 7 is a block diagram of yet another exemplary embodiment of a service advisor system.

### DETAILED DESCRIPTION

Various embodiments of methods and apparatus for providing advice to a service provider in a service advisor system comprising a virtualization platform and an analytics platform. In certain embodiments, the method includes accessing customer, network, and service data stored in disparate data sources via the virtualization platform, processing the data via analytics platform using a service advisor algorithm to form conclusions and predictions based on the data and to generate advice based on the data, conclusions, and predictions. In one embodiment, the service advisor algorithm is for management of customer churn and enables the service provider to consider select aspects of the data, conclusions, predictions, and advice in relation to reduction of customer churn. In another embodiment, the service advisor algorithm is for personalization of service provided to customers, and enables the service provider to consider select aspects of the data, conclusions, predictions, and advice in relation to improvement of personalized services. In yet another embodiment, the service advisor algorithm is for targeted marketing of services to customers or non-customers and enables the service provider to consider select aspects of the data, conclusions, predictions, and advice in relation to improvement of targeted marketing. In still another embodiment, the service advisor algorithm is for management of the network infrastructure and enables the service provider to consider select aspects of the data, conclusions, predictions, and advice in relation to improvement of network infrastructure capabilities.

This disclosure provides techniques for using data analytics to process data from different data sources in a service provider network infrastructure to draw meaningful conclusions that can be used to suggest new services, upgrades to services, personalization of services, management of customer churn, targeted marketing, management of network health, and management of network infrastructure that will benefit both the service provider and subscribers. In particular, these techniques can result in monetization of information for service providers.

In one embodiment, an apparatus for providing advice to a service provider includes a common data analytics engine with pluggable algorithms and a data virtualization system that work together to provide advice to the service provider that may be used for a specific purpose, such as further actions regarding improvement of personalized services, reduction of customer churn, improvement of targeted marketing, or improvement of network infrastructure capabilities. Common data warehousing techniques make service provider data reusable by many solutions and hence more effective.

The data analytics engine with pluggable analytics algorithms provides a service advisor with algorithms built for various specific purposes. The data that resides on different systems can be all virtualized by platforms to present a single logical view. An example of a virtualization platform is the 8660 Data Grid Suite from Alcatel-Lucent of Paris, France. The various analytics algorithms work to produce results for a menu of possibilities, such as personalized services, churn management, targeted advertising, and proactive network performance monitoring and management. The service advisor can include some basic built-in algorithms for most likely scenarios. Service advisor algorithms can be custom built as well. The algorithms can be in-house algorithms prepared by the service provider or algorithms licensed from third parties. The results of the analytics can be viewed or connected into other systems such as customer resource management (CRM) systems or network management systems (NMS) for review in order to take further actions for improvement of personalized services, reduction of customer churn, improvement of targeted marketing, or improvement of network infrastructure capabilities.

Network operators own enormous amount of information about their customers and their networks. There is a huge potential to monetize this data. However, operators are not currently able to take advantage of this opportunity because monetization of this data has a number of hurdles for the operators. Some of these hurdles are: i) data resides in legacy and disparate systems and is hard to get to; ii) data is managed and controlled by different organizations so access and ownership is a hindrance; and iii) there is no central approach to data mining and analytics. As a result, there is duplication of effort by various different organizations and often service providers are reinventing the wheel because of these difficulties.

The service advisor addresses this problem through a platform where data can be gathered from many disparate systems and translated to a common format so that a number of data mining algorithms can be applied to achieve operator goals, such as personalized services, customer churn reduction, targeted marketing, and network performance management.

The service advisor has both direct and indirect benefits. By providing and charging for new innovative services to consumers (i.e., customers, subscribers, etc.) of the service there is potential to monetize the service provider data and service provider services. By providing better network capability and new or improved personalized services, an indirect benefit of loyalty and less customer churn is achieved.

The service advisor includes a common analytics engine/platform that can take in customized analytics algorithms—so the solution is expandable easily. At best, existing solutions are only focused on a specific solution and are more restricted and less expandable. Also data virtualization makes it possible to draw data from many different systems easily.

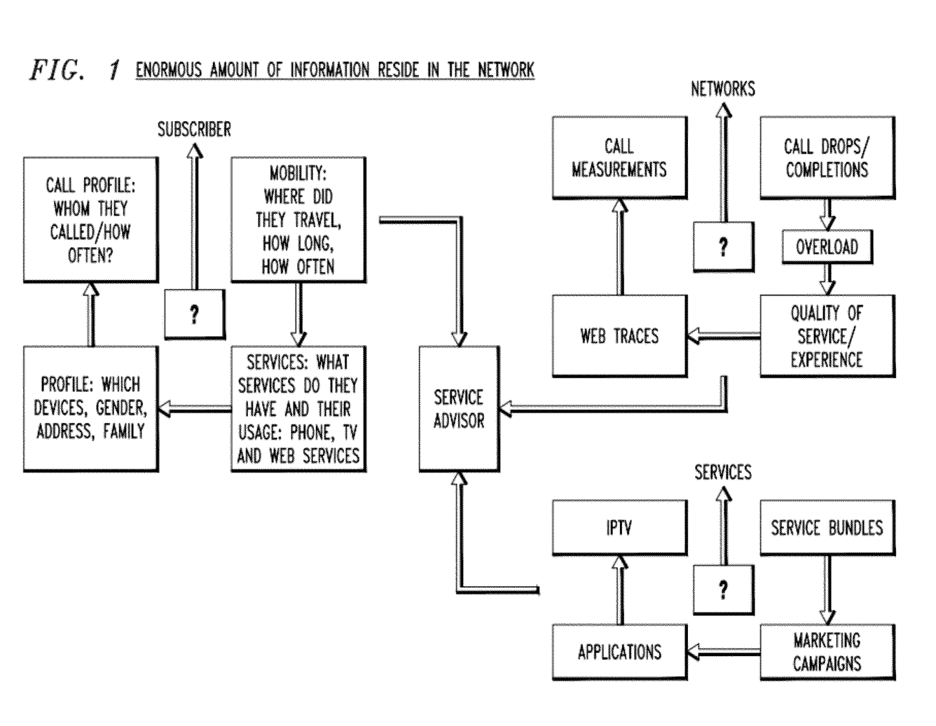

The disclosure is directed to analyzing data in service provider networks, which enables a service provider to suggest new and/or personalized services, manage subscriber churn, and provide useful network analyses and predictions. Referring now to the drawings wherein the showings are for purposes of illustrating the exemplary embodiments only and not for purposes of limiting the claimed subject matter, FIG. 1 depicts a service provider with access to vast amounts of data about their subscribers, which include where they live, their gender, age, income, family size (e.g., through family plans), etc. Through actual provision of services - e.g., phone, digital TV, IPTV, VoIP, web and broadband services—service providers may have access to the following data about a subscriber, as well: i) the TV channels that the subscriber's family watches and the duration and frequency; ii) the websites visited; iii) the wireline and wireless call patterns and whom the subscriber calls (e.g., through call detail records (CDRs); iv) what applications he/she uses (e.g., through techniques like deep packet inspection (DPI)); v) the type of devices he/she has and for how long; vi) music, ringtones and video download choices; vii) where the subscriber travels (e.g., through cell-ID records); or viii) who are in his/her contact lists; etc. The network providers may also have access to network measurement data from various network elements having information, such as per-call-measurement data (PCMD) and key performance indicators/indexes (KPI).

Some of the aforementioned data may be directly obtained, and the other data may be derived by mining one or more data systems by generating conclusions and predictions from the original data. Through data analytics, a service provider is capable of drawing meaningful conclusions that can result in new and/or personalized services and predictions about network behaviors. The latter can be used by the service provider to improve its services and thereby increase its revenue.

However, the following problems have been recognized: i) data resides in legacy and disparate systems, which may be hard to gather; ii) data is managed and controlled by different organizations, and its ownership and the right to access the data may be at issue; and iii) there is no central approach to data mining and analytics, which may result in duplication of efforts by various organizations.

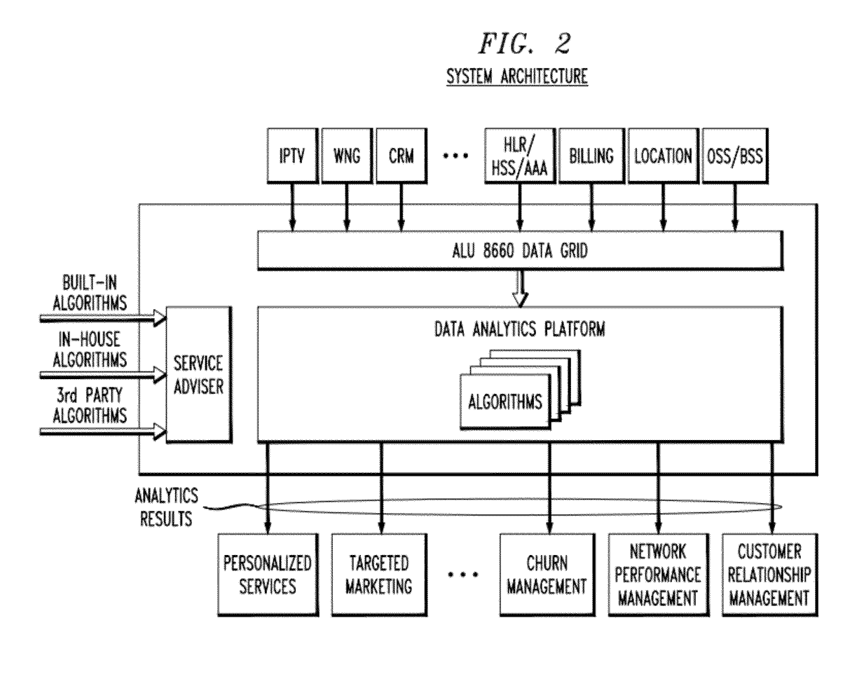

To solve one or more of such problems, in one embodiment, the service advisor comprises a common data analytics engine with pluggable analytics algorithms that may be built for specific purposes. Referring to FIG. 2, the data that resides on different systems can be visualized by platforms, such as the 8660 Data Grid Suite, to present a single logical view. The different analytics algorithms may work to produce results for a menu of possibilities, such as personalized services, customer churn management, targeted advertising, and proactive network performance monitoring. The offering may be basic built-in algorithms or custom-built algorithms. The results of the analytics may be viewed or communicated to other systems, such as a CRM system or an NMS for further actions regarding improvement of personalized services, reduction of customer churn, improvement of targeted marketing, or improvement of network infrastructure capabilities.

The aforementioned common data analytics engine may perform the following process: i) identify/formulate such questions/problems as what is to be achieved with the data, what content from the data is to be sought, etc.; ii) identify the data that is relevant to the above question/problem by: ii.a) identifying where it resides, its format, access capability, and ii.b) formulating the algorithm to be used on the data; iii) gather/access (and store) the data for analysis; iv) run the analysis algorithm; and v) present the results and findings and store as reports for future use.

To illustrate an embodiment according to the service advisor, consider the following scenario. Subscriber A usually makes a lot of phone calls, say, to his mother, but only after 7:00 pm to save money. Suppose she is hospitalized and he wants to check on her more often during various times of the day. Subscriber A may (or may not) realize that a service provider offers a “friends and family” service plan, of which he can take advantage to save money in view of the new call pattern, and may have to go through the pains of changing his service plan.

However, the service advisor in one embodiment is capable of detecting Subscriber A's new call pattern and suggesting/making a switch to a more appropriate (e.g., more cost-saving) service plan for him on an ongoing basis. Accordingly, a service provider may offer a service plan advisor tool to subscribers for a monthly charge, which helps them save money and automatically change service plans on an ongoing basis. Alternatively, this tool may be offered on a web portal of the service provider.

The service advisor in another embodiment may be used to perform targeted marketing. For example, the service advisor may conclude that Subscriber B goes to movies often after analyzing his/her location records, service history, etc. Accordingly, the service advisor may suggest downloads of videos/trailers, music, etc, related to the latest movies to Subscriber B's handset, for example.

The service advisor in yet another embodiment may be used to perform personalized services. For example, the service advisor may realize through data analytics that four people (perhaps “friends”) communicate a lot with one another via text, voice and other applications. Let's say three of the four people are already subscribers of the service provider. In this example, the service advisor may suggest to the other person who currently is not a subscriber to join a “friends network” where he/she can have a more economical, all-inclusive plan for those services he/she has been using with his/her friends frequently, plus other services of his/her choice, thereby suggesting/prescribing personalized services to a non-subscriber in the hopes of gaining subscribership.

The service advisor in still another embodiment may be used to perform proactive network monitoring. For example, by examining call records and historical usage patterns at venues of large events (e.g., stadiums, arenas, etc.), the service advisor may provide a service provider with better understanding of how to tune/upgrade/provision its networks. The service advisor may provide statistics about the number of users making calls to/from certain neighborhoods during, say, a Mets game, and may suggest adding/re-allocating network capacity to better serve the corresponding parts of the networks. It also may derive any vehicle traffic information in advance of an event to help the city better plan traffic redirections, lane changes, etc. to prevent congestions around a venue of the event. However, the benefits from such service advice may not be immediately apparent to a subscriber. The service provider may sell some of such service advice to other entities such as civic organizations.

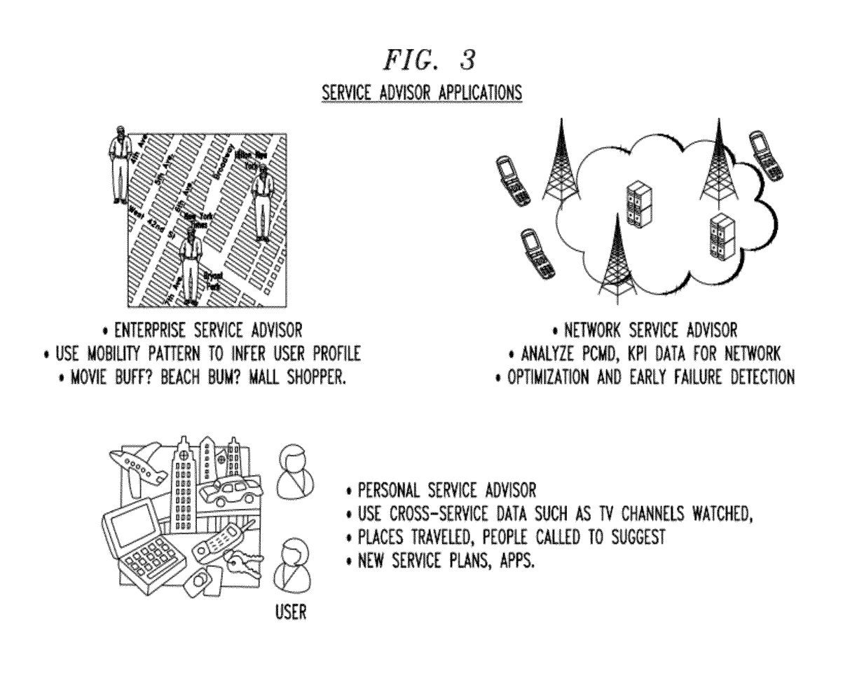

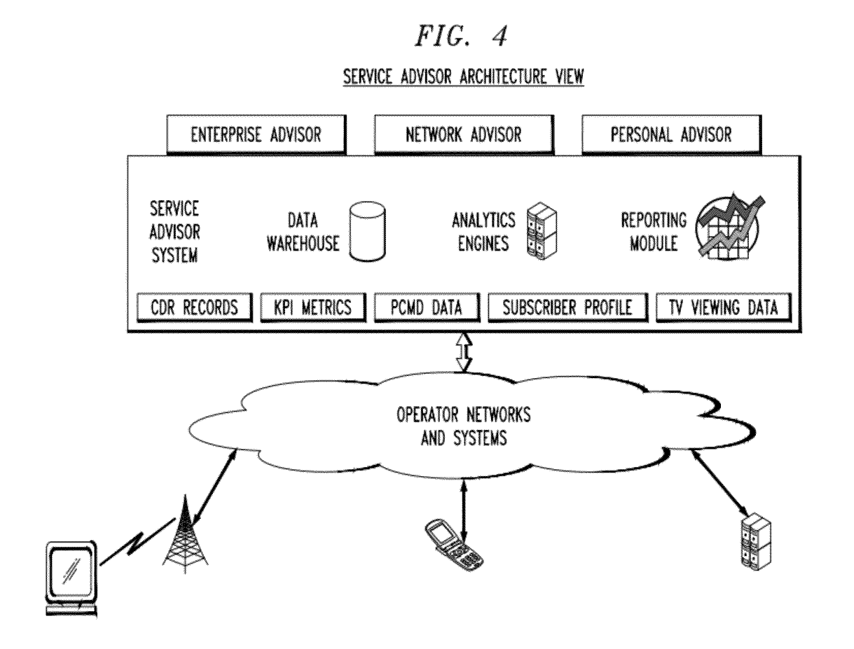

Referring to FIGS. 3 and 4, the service advisor according to other embodiments may be (1) a personal service advisor employing data-mining and analysis tools to generate better and customized services/plans for individual subscribers to help retain their loyalty, (2) an enterprise/business service advisor employing data-mining and analysis tools to provide aggregated or context sensitive information to businesses, which enables them to better target their products to customers, and/or (3) a network service advisor which analyzes network records and performance indexes to provide early failure detection and correction strategies which enable a service provider to enhance network performance and take precautions against failures. Such records and indexes, e.g., KPI, contain information about dropped calls, failed call attempts, etc. By analyzing these records and indexes in real time, the network service advisor can promptly predict and identify network issues, thereby enabling the service provider to take any necessary preventive and corrective measures to resolve such issues earliest possible.

Thus, using the service advisor, a service provider advantageously reduces churn of subscribers by suggesting/tailoring more appropriate services to subscribers, and sells additional services to them. The service provider also can identify potential new subscribers and entice them to join by offering to them personalized plans and preferential treatments. In addition, the service provider can benefit from predictions and early identification of network issues to better maintain its networks, thereby improving subscribers' perception of the network/service reliability, conducive to increased loyalty and less chum. Further, the service provider can sell to other entities data mined by the service advisor from CDRs and other service records.

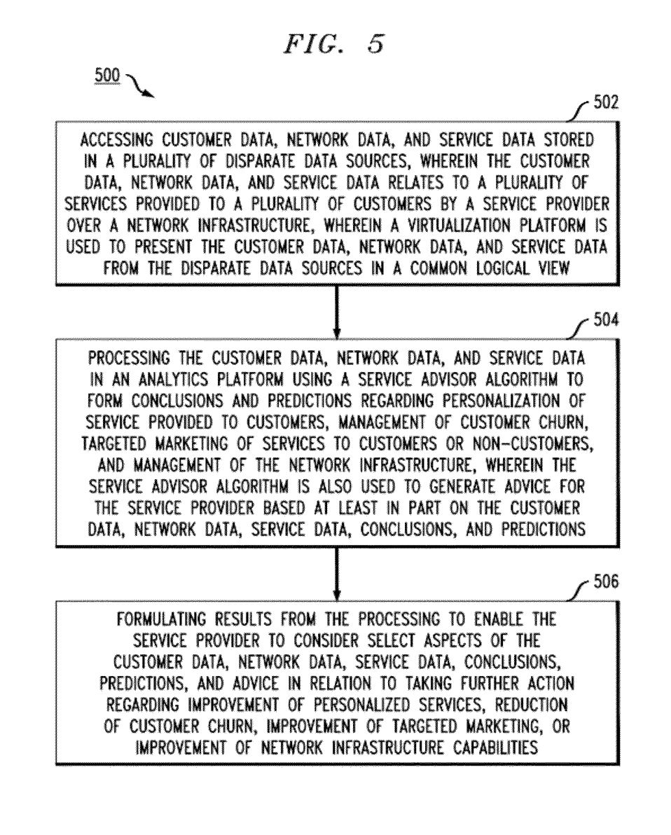

With reference to FIG. 5, an exemplary embodiment of a process 500 for providing advice to a service provider begins at 502 where customer data, network data, and service data stored in a plurality of disparate data sources is accessed. The customer data, network data, and service data relates to a plurality of services provided to a plurality of customers by a service provider over a network infrastructure. A virtualization platform is used to present the customer data, network data, and service data from the disparate data sources in a common logical view. Next, the customer data, network data, and service data is processed in an analytics platform using a service advisor algorithm to form conclusions and predictions regarding personalization of service provided to customers, management of customer churn, targeted marketing of services to customers or non-customers, and management of the network infrastructure (504). The service advisor algorithm is also used to generate advice for the service provider based at least in part on the customer data, network data, service data, conclusions, and predictions. At 506, results from the processing are formulated to enable the service provider to consider select aspects of the customer data, network data, service data, conclusions, predictions, and advice in relation to taking further action regarding improvement of personalized services, reduction of customer churn, improvement of targeted marketing, or improvement of network infrastructure capabilities.

In another embodiment, the process 500 also includes receiving a request for advice from an input device in operative communication with the analytics platform and accessible to the service provider, the received request relating to at least one of improvement of personalized services, reduction of customer churn, improvement of targeted marketing, and improvement of network infrastructure capabilities. In this embodiment, the accessing in 502, processing in 504, and formulating in 506 are tailored at least in part to the request.

In yet another embodiment, the process 500 also includes receiving the formulated results at an output device in operative communication with the analytics platform. The output device being accessible to the service provider for review of the formulated results in relation to taking further action regarding at least one of improvement of personalized services, reduction of customer churn, improvement of targeted marketing, and improvement of network infrastructure capabilities. In this embodiment, the output device may include a display device adapted to display the formulated results to the service provider, a storage device adapted to store the formulated results for access by the service provider, a printing device adapted to print the formulated results for use by the service provider, and other suitable types of output devices in any suitable combination.

In still another embodiment, the process 500 also includes formulating results from the processing to enable the service provider to consider select aspects of the customer data, network data, service data, conclusions, predictions, and advice in relation to taking further action regarding at least one of i) targeted marketing of personalized services to a select customer based at least in part on actual or predicted relationships between the corresponding select customer and other customers or non-customers, ii) targeted marketing of personalized services to a non-customer based at least in part on actual or predicted relationships between existing customers and the corresponding non-customer, and iii) targeted marketing of select aspects of the customer data, network data, service data, conclusions, predictions, or advice to a commercial enterprise based at least in part on actual or predicted relationships between existing customers and products or services offered by the corresponding commercial enterprise.

In another embodiment of the process 500, the customer data includes information indicative of behavior and preferences of existing customers of the service provider. The customer data may include customer profile information, customer device information, service plan information, service feature information, service bundle information, service usage information, feature usage information, demographic information, location information, travel information, elapsed time information, calendar time information, contact list information, entertainment venue information, targeted marketing campaign information, and other suitable types of customer data in any suitable combination.

In this embodiment, the customer device information may include device type information, device ownership information, device operation information, device status information, and other suitable types of customer device information in any suitable combination. The service usage information may include television (TV) viewing information, radio listening information, music listening information, Internet usage information, visited website information, telephone call information, called party information, call or charging detail record (CDR) information, software application usage information, deep packet inspection (DPI) information, interactive communication usage information, multimedia download information, multimedia on-demand usage information, streaming multimedia usage information, broadband usage information, and other suitable types of service usage information in any suitable combination. The demographic information may include address information, gender information, age information, income information, family information, geographic information, and other suitable types of demographic information in any suitable combination. The location information may include global positioning system (GPS) information, mobility management information, cell identification record information, and other suitable types of location information in any suitable combination. The targeted marketing campaign information including products or services offered by an enterprise customer or non-customer, products or services from the enterprise customer or non-customer for which the service provider customer has requested information, enterprise customers or non- customers with products or services for which the service provider has elected or agreed to pursue targeted marketing opportunities related to its existing customers, and other suitable types of targeted marketing campaign information in any suitable combination.

In yet another embodiment of the process 500, the network data includes information indicative of characteristics and behavior of the network infrastructure. The network data may include network architecture information, network configuration information, network device information, network resource information, network usage information, network performance information, geographic information, elapsed time information, calendar time information, entertainment venue information, and other suitable types of network data in any suitable combination.

In this embodiment, the network performance information may include network measurement information, key performance indicator or index (KPI) information, quality of service (QoS) information, dropped call information, failed call attempt information, completed call information, overload information, and other suitable types of network performance information in any suitable combination. The network resource information may include network capacity information, network device allocation information, network resource allocation information, and other suitable types of network resource information in any suitable combination. The network usage information may include web trace information, per call measurement data (PCMD) information, communication routing information, network load information, network status information, and other suitable types of network usage information in any suitable combination. The network device information may include device type information, device operating record information, device maintenance record information, device status information, and other suitable types of network device information in any suitable combination. The geographic information may include location information, global positioning system (GPS) information, regional area information, local area information, service coverage information, cellular coverage information, and other suitable types of geographic information in any suitable combination.

In still another embodiment of the process 500, the service data includes information indicative of services, features, and options available to customers from the service provider. The service data may include interactive communication service information, Internet access service information, multimedia download service information, multimedia on-demand service information, streaming multimedia service information, broadband service information, service plan information, service feature information, service bundle information, geographic information, elapsed time information, calendar time information, entertainment venue information, targeted marketing campaign information, and other suitable types of network data in any suitable combination.

In this embodiment, the interactive communication service information may include voice communication service information, landline telephone service information, wireless communication service information, voice over internet protocol (VoIP) service information, multimedia communication service information, broadband service information, text messaging service information, short message service (SMS) information, instant message (IM) service information, electronic mail (e-mail) service information, and other suitable types of interactive communication service information in any suitable combination. The multimedia download service information may include video download service information, image download service information, audio download service information, music download service information, ringtone download service information, and other suitable types of multimedia download service information in any suitable combination. The multimedia on-demand service information may include video on-demand (VOD) service information, image on-demand service information, audio on-demand service information, music on-demand service information, and other suitable types of multimedia on-demand service information in any suitable combination. The streaming multimedia service information may include broadcast television (TV) service information, broadcast radio service information, satellite TV service information, satellite radio service information, cable TV service information, high definition TV service information, digital TV service information, Internet protocol (IP) TV (IPTV) service information, IP radio service information, and other suitable types of streaming multimedia service information in any suitable combination. The geographic information may include location information, global positioning system (GPS) information, regional area information, local area information, service coverage information, cellular coverage information, and other suitable types of geographic information in any suitable combination. The targeted marketing campaign information including products or services offered by enterprise customers or non-customers for which the service provider has elected to pursue targeted marketing opportunities related to its existing customers, enterprise customers or non-customers that offer such products or services, and other suitable types of targeted marketing campaign information in any suitable combination.

In still yet another embodiment of the process 500, the plurality of disparate data sources include data sources that differ for different generations of technology, data sources that differ for different types of networks, data sources that differ for different types of services, data sources that differ for different types of data, and other suitable types of disparate data sources in any suitable combination.

In another embodiment of the process 500, the disparate data sources that differ for different generations of technology may include legacy data sources, current generation data sources, next generation data sources, long term evolution (LTE) data sources, and data sources for other generations of technology in any suitable combination. The disparate data sources for different types of networks may include public switched telephone network (PSTN) data sources, wireless network data sources, internet protocol (IP) network data sources, IP multimedia subsystem (IMS) network data sources, satellite communication network data sources, cable television (TV) network data sources, and data sources for other suitable types of networks in any suitable combination. The disparate data sources for different types of services may include interactive communication service data sources, Internet access service data sources, multimedia download service data sources, multimedia on-demand service data sources, streaming multimedia service data sources, broadband service data sources, entertainment venue data sources, targeted marketing campaign data sources, an internet protocol television (TV) service data source, and data sources for other suitable types of services in any suitable combination. The disparate data sources for different types of data may include a customer data source, a network data source, a service data source, a billing data source, a location data source, a wireless network guardian (WNG) data source, a customer relations management (CRM) system data source, a home location register (HLR) data source, a home subscriber server (HSS) data source, an authentication, authorization, and accounting (AAA) service data source, an operational support system (OSS) data source, a billing support system (BSS) data source, and data sources for other suitable types of data in any suitable combination.

In yet another embodiment of the process 500, the plurality of services include an interactive communication service, an Internet access service, a multimedia download service, a multimedia on-demand service, a streaming multimedia service, a broadband service, and other suitable types of services in any suitable combination.

In still another embodiment of the process 500, the plurality of customers include individual subscribers, individual customers, residential customers, enterprise customers, commercial customers, and other suitable types of customers in any suitable combination.

In still yet another embodiment of the process 500, the service advisor algorithm includes a personalized service algorithm to form conclusions and predictions for at least one select customer, wherein the personalized service algorithm generates advice regarding personalization of services for each corresponding select customer. The conclusions and predictions may include service usage patterns, feature usage patterns, demographic patterns, location patterns, travel patterns, elapsed time patterns, calendar time patterns, contact list patterns, entertainment venue patterns, or other suitable types of conclusions and predictions in any suitable combination. The advice may include personalization of an interactive communication service, personalization of an Internet access service, personalization of a multimedia download service, personalization of a multimedia on-demand service, personalization of a streaming multimedia service, personalization of a broadband service, personalization of a service plan, personalization of a service feature, personalization of a service bundle, or other suitable types of advice in any suitable combination.

In another embodiment of the process 500, the service advisor algorithm includes a customer churn algorithm to form conclusions and predictions for personalization of services for at least some portion of existing customers and management of at least some portion of the network infrastructure, wherein the customer churn algorithm generates advice regarding personalization of services for the corresponding portion of existing customers and management of the corresponding portion of the network infrastructure. The conclusions and predictions may include service usage patterns, feature usage patterns, demographic patterns, location patterns, travel patterns, contact list patterns, network usage patterns, network performance patterns, geographic patterns, elapsed time patterns, calendar time patterns, entertainment venue patterns, or other suitable types of conclusions and predictions in any suitable combination. The advice may include personalization of an interactive communication service, personalization of an Internet access service, personalization of a multimedia download service, personalization of a multimedia on-demand service, personalization of a streaming multimedia service, personalization of a broadband service, personalization of a service plan, personalization of a service feature, personalization of a service bundle, management of a network architecture, management of a network configuration, management of a network device, management of a network resource, or other suitable types of advice in any suitable combination.

In yet another embodiment of the process 500, the service advisor algorithm includes a targeted marketing algorithm to form conclusions and predictions for at least one of targeted marketing to an existing customer, targeted marketing to a non-customer, and targeted marketing to an enterprise customer or non-customer, wherein the targeted marketing algorithm generates advice regarding targeted marketing of services to the corresponding existing customer, non-customer, enterprise customer, and enterprise non-customer. The conclusions and predictions regarding targeted marketing to the existing customer may include service usage patterns, feature usage patterns, demographic patterns, location patterns, travel patterns, elapsed time patterns, calendar time patterns, contact list patterns, entertainment venue patterns, or other suitable types of conclusions and predictions in any suitable combination. The conclusions and predictions regarding targeted marketing to the non-customer may be based at least in part on relationships between existing customers and the non-customer. The conclusions and predictions regarding targeted marketing to the enterprise customer or non-customer may be based at least in part on relationships between existing customers and products or services offered by the enterprise customer or non-customer.

In this embodiment, the advice regarding targeted marketing to the existing customer and the non-customer may include advice regarding targeted marketing of an interactive communication service, an Internet access service, a multimedia download service, a multimedia on-demand service, a streaming multimedia service, a broadband service, a service plan, a service feature, a service bundle, or other suitable types of advice in any suitable combination. The advice regarding targeted marketing to the enterprise customer or non-customer may include targeted marketing of select aspects of customer data, conclusions, predictions, or advice relating to relationships between existing customers and products or services offered by the enterprise customer or non-customer or other suitable types of advice in any suitable combination.

In still another embodiment of the process 500, the service advisor algorithm includes a network management algorithm to form conclusions and predictions regarding management of the network infrastructure, wherein the network management algorithm generates advice regarding management of the network infrastructure. The conclusions and predictions may include network usage patterns, network performance patterns, geographic patterns, elapsed time patterns, calendar time patterns, entertainment venue patterns, or other suitable types of conclusions and predictions in any suitable combination. The advice may include management of a network architecture, management of a network configuration, management of a network device, management of a network resource, or other suitable types of advice in any suitable combination. The management of network resources may include monitoring network health, monitoring network behavior, tuning network resources, upgrading network resources, provisioning network resources, allocating network resources, and other suitable types of management of network resources in any suitable combination.

In still yet another embodiment of the process 500, the formulated results include conclusions, predictions, and advice for consideration and further action regarding improvement of personalized services for at least one select customer. The conclusions and predictions in the formulated results may include service usage patterns, feature usage patterns, demographic patterns, location patterns, travel patterns, elapsed time patterns, calendar time patterns, contact list patterns, entertainment venue patterns, or other suitable types of conclusions or predictions in any suitable combination. The advice in the formulated results may include personalization of an interactive communication service, personalization of an Internet access service, personalization of a multimedia download service, personalization of a multimedia on-demand service, personalization of a streaming multimedia service, personalization of a broadband service, personalization of a service plan, personalization of a service feature, personalization of a service bundle, or other suitable types of advice in any suitable combination.

In another embodiment of the process 500, the formulated results include conclusions, predictions, and advice for consideration and further action regarding reduction of customer churn for at least some portion of existing customers. The conclusions and predictions in the formulated results may include service usage patterns, feature usage patterns, demographic patterns, location patterns, travel patterns, contact list patterns, network usage patterns, network performance patterns, geographic patterns, elapsed time patterns, calendar time patterns, entertainment venue patterns, or other suitable types of conclusions or predictions in any suitable combination. The advice in the formulated results may include personalization of an interactive communication service, personalization of an Internet access service, personalization of a multimedia download service, personalization of a multimedia on-demand service, personalization of a streaming multimedia service, personalization of a broadband service, personalization of a service plan, personalization of a service feature, personalization of a service bundle, management of a network architecture, management of a network configuration, management of a network device, management of a network resource, or other suitable types of advice in any suitable combination.

In yet another embodiment of the process 500, the formulated results include conclusions, predictions, and advice for consideration and further action regarding improvement of targeted marketing to at least one of an existing customer, a non-customer, and an enterprise customer or non-customer. The conclusions and predictions in the formulated results regarding the existing customer may include service usage patterns, feature usage patterns, demographic patterns, location patterns, travel patterns, elapsed time patterns, calendar time patterns, contact list patterns, entertainment venue patterns, or other suitable types of conclusions or predictions in any suitable combination. The conclusions and predictions in the formulated results regarding the non-customer may be based at least in part on relationships between existing customers and the non-customer. The conclusions and predictions in the formulated results regarding the enterprise customer or non-customer may be based at least in part on relationships between existing customers and products or services offered by the enterprise customer or non-customer.

In this embodiment, the advice in the formulated results regarding targeted marketing to the existing customer and the non-customer may include advice regarding targeted marketing of an interactive communication service, an Internet access service, a multimedia download service, a multimedia on-demand service, a streaming multimedia service, a broadband service, a new or modified service plan, a new or modified service feature, a new or modified service bundle, or other suitable types of advice in any suitable combination. The advice in the formulated results regarding targeted marketing to the enterprise customer or non-customer may include advice regarding targeted marketing of select aspects of customer data, conclusions, predictions, advice relating to relationships between existing customers and products or services offered by the enterprise customer or non-customer, or other suitable types of advice in any suitable combination.

In still another embodiment of the process 500, the formulated results include conclusions, predictions, and advice regarding improvement of network infrastructure capabilities through management of the network infrastructure. The conclusions and predictions in the formulated results may include network usage patterns, network performance patterns, geographic patterns, elapsed time patterns, calendar time patterns, entertainment venue patterns, or other suitable types of conclusions or predictions in any suitable combination. The advice in the formulated results may include management of a network architecture, management of a network configuration, management of a network device, management of a network resource, or other suitable types of advice in any suitable combination.

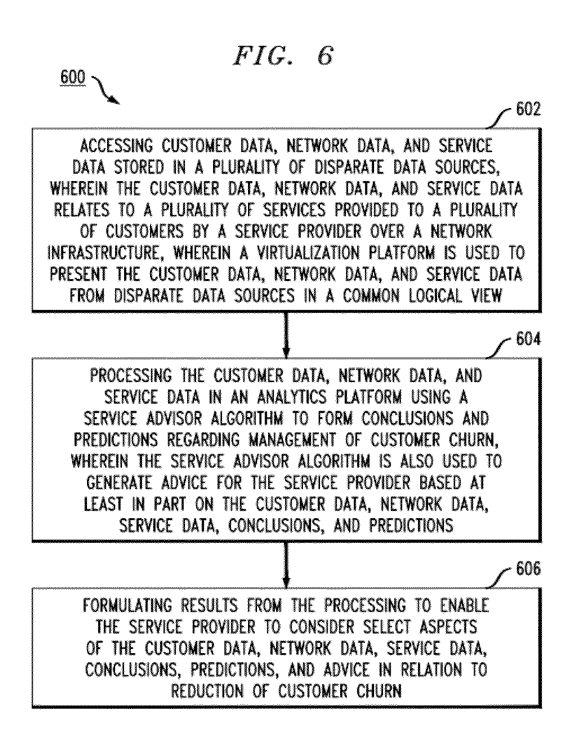

With reference to FIG. 6, another exemplary embodiment of a process 600 for providing advice to a service provider begins at 602 where customer data, network data, and service data stored in a plurality of disparate data sources is accessed. The customer data, network data, and service data relates to a plurality of services provided to a plurality of customers by a service provider over a network infrastructure. A virtualization platform is used to present the customer data, network data, and service data from the disparate data sources in a common logical view. Next, the customer data, network data, and service data in an analytics platform is processed using a service advisor algorithm to form conclusions and predictions regarding management of customer churn (604). The service advisor algorithm is also used to generate advice for the service provider based at least in part on the customer data, network data, service data, conclusions, and predictions. At 606, results from the processing are formulated to enable the service provider to consider select aspects of the customer data, network data, service data, conclusions, predictions, and advice in relation to reduction of customer churn.

In another embodiment, the process 600 also includes processing the customer data, network data, and service data in the analytics platform using the service advisor algorithm to form conclusions and predictions regarding personalization of service provided to customers. In this embodiment, results from the processing are formulated to enable the service provider to consider select aspects of the customer data, network data, service data, conclusions, predictions, and advice in relation to taking further action regarding improvement of personalized services.

In yet another embodiment, the process 600 also includes processing the customer data, network data, and service data in the analytics platform using the service advisor algorithm to form conclusions and predictions regarding targeted marketing of services to customers or non-customers. In this embodiment, results from the processing are formulated to enable the service provider to consider select aspects of the customer data, network data, service data, conclusions, predictions, and advice in relation to taking further action regarding improvement of targeted marketing.

In still another embodiment, the process 600 also includes processing the customer data, network data, and service data in the analytics platform using the service advisor algorithm to form conclusions and predictions regarding management of the network infrastructure. In this embodiment, results from the processing are formulated to enable the service provider to consider select aspects of the customer data, network data, service data, conclusions, predictions, and advice in relation to taking further action regarding improvement of network infrastructure capabilities.

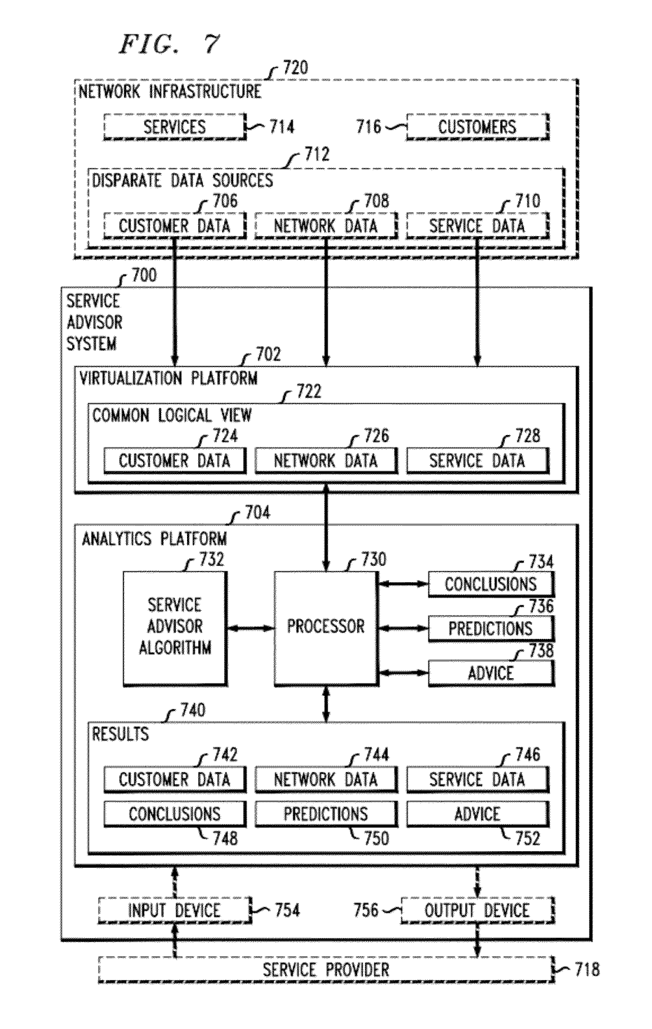

With reference to FIG. 7, an exemplary embodiment of a service advisor system 700 includes a virtualization platform 702 and an analytics platform 704. The virtualization platform accesses customer data 706, network data 708, and service data 710 stored in a plurality of disparate data sources 712. The customer data 706, network data 708, and service data 710 relates to a plurality of services 714 provided to a plurality of customers 716 by a service provider 718 over a network infrastructure 720. The virtualization platform 702 presents the customer data 706, network data 708, and service data 710 from the disparate data sources 712 in a common logical view 722.

The analytics platform 704 is in operative communication with the virtualization platform 702 for processing the customer data 724, network data 726, and service data 728 via a processor 730 using a service advisor algorithm 732 to form conclusions 734 and predictions 736 regarding personalization of service provided to customers, management of customer churn, targeted marketing of services to customers or non-customers, and management of the network infrastructure. The processer 730 also uses the service advisor algorithm 732 to generate advice 738 for the service provider 718 based at least in part on the customer data 724, network data 726, service data 728, conclusions 734, and predictions 736. The processor 730 in the analytics platform 704 also uses the service advisor algorithm 732 for formulating results 740 from the processing to enable the service provider 718 to consider select aspects of the customer data 742, network data 744, service data 746, conclusions 748, predictions 750, and advice 752 in relation to taking further action regarding improvement of personalized services, reduction of customer churn, improvement of targeted marketing, or improvement of network infrastructure capabilities.

In another embodiment, the service advisor system 700 also includes an input device 754 in operative communication with the analytics platform 704 and accessible to the service provider 718 for receiving a request for advice relating to at least one of improvement of personalized services, reduction of customer churn, improvement of targeted marketing, and improvement of network infrastructure capabilities. In this embodiment, the accessing by the virtualization platform 702, the processing by the analytics platform 704, and the formulating by the analytics platform 704 are tailored at least in part to the request.

In yet another embodiment, the service advisor system 700 also includes an output device 756 in operative communication with the analytics platform 704 for receiving the formulated results 740. In this embodiment, the output device 756 is accessible to the service provider 718 for review of the formulated results 740 in relation to taking further action regarding at least one of improvement of personalized services, reduction of customer churn, improvement of targeted marketing, and improvement of network infrastructure capabilities. The output device 756 may include a display device adapted to display the formulated results to the service provider, a storage device adapted to store the formulated results for access by the service provider, a printing device adapted to print the formulated results for use by the service provider, or other suitable types of output devices in any suitable combination.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A method for providing advice to a service provider, comprising:
a) accessing customer data, network data, and service data stored in a plurality of disparate data sources, wherein the customer data, network data, and service data relates to a plurality of services provided to a plurality of customers by a service provider over a network infrastructure, wherein a virtualization platform is used to present the customer data, network data, and service data from the disparate data sources in a common logical view;
b) processing the customer data, network data, and service data in an analytics platform using a service advisor algorithm to form conclusions and predictions regarding personalization of service provided to customers, management of customer churn, targeted marketing of services to customers or non-customers, and management of the network infrastructure, wherein the service advisor algorithm is also used to generate advice for the service provider based at least in part on the customer data, network data, service data, conclusions, and predictions; and
c) formulating results from the processing to enable the service provider to consider select aspects of the customer data, network data, service data, conclusions, predictions, and advice in relation to taking further action regarding improvement of personalized services, reduction of customer churn, improvement of targeted marketing, or improvement of network infrastructure capabilities.

2. The method set forth in claim 1, further comprising:
d) receiving a request for advice from an input device in operative communication with the analytics platform and accessible to the service provider, the received request relating to at least one of improvement of personalized services, reduction of customer churn, improvement of targeted marketing, and improvement of network infrastructure capabilities, wherein the accessing in a), processing in b), and formulating in c) are tailored at least in part to the request.

3. The method set forth in claim 1, further comprising:
d) receiving the formulated results at an output device in operative communication with the analytics platform, the output device being accessible to the service provider for review of the formulated results in relation to taking further action regarding at least one of improvement of personalized services, reduction of customer churn, improvement of targeted marketing, and improvement of network infrastructure capabilities.

4. The method set forth in claim 1, further comprising:
d) formulating results from the processing to enable the service provider to consider select aspects of the customer data, network data, service data, conclusions, predictions, and advice in relation to taking further action regarding at least one of targeted marketing of personalized services to a select customer based at least in part on actual or predicted relationships between the corresponding select customer and other customers or non-customers, targeted marketing of personalized services to a non-customer based at least in part on actual or predicted relationships between existing customers and the corresponding non-customer, and targeted marketing of select aspects of the customer data, network data, service data, conclusions, predictions, or advice to a commercial enterprise based at least in part on actual or predicted relationships between existing customers and products or services offered by the corresponding commercial enterprise.

5. The method set forth in claim 1 wherein the customer data includes information indicative of behavior and preferences of existing customers of the service provider, the network data includes information indicative of characteristics and behavior of the network infrastructure, and the service data includes information indicative of services, features, and options available to customers from the service provider.

6. The method set forth in claim 1 wherein the service advisor algorithm includes a personalized service algorithm to form conclusions and predictions for at least one select customer, wherein the personalized service algorithm generates advice regarding personalization of services for each corresponding select customer.

7. The method set forth in claim 1 wherein the service advisor algorithm includes a customer churn algorithm to form conclusions and predictions for personalization of services for at least some portion of existing customers and management of at least some portion of the network infrastructure, wherein the customer churn algorithm generates advice regarding personalization of services for the corresponding portion of existing customers and management of the corresponding portion of the network infrastructure.

8. The method set forth in claim 1 wherein the service advisor algorithm includes a targeted marketing algorithm to form conclusions and predictions for at least one of targeted marketing to an existing customer, targeted marketing to a non-customer, and targeted marketing to an enterprise customer or non-customer, wherein the targeted marketing algorithm generates advice regarding targeted marketing of services to the corresponding existing customer, non-customer, enterprise customer, and enterprise non-customer.

9. The method set forth in claim 1 wherein the service advisor algorithm includes a network management algorithm to form conclusions and predictions regarding management of the network infrastructure, wherein the network management algorithm generates advice regarding management of the network infrastructure.

10. The method set forth in claim 1 wherein the formulated results include conclusions, predictions, and advice for consideration and further action regarding improvement of personalized services for at least one select customer.

11. The method set forth in claim 1 wherein the formulated results include conclusions, predictions, and advice for consideration and further action regarding reduction of customer churn for at least some portion of existing customers.

12. The method set forth in claim 1 wherein the formulated results include conclusions, predictions, and advice for consideration and further action regarding improvement of targeted marketing to at least one of an existing customer, a non-customer, and an enterprise customer or non-customer.

13. The method set forth in claim 1 wherein the formulated results include conclusions, predictions, and advice regarding improvement of network infrastructure capabilities through management of the network infrastructure.

14. A method for providing advice to a service provider, comprising:
a) accessing customer data, network data, and service data stored in a plurality of disparate data sources, wherein the customer data, network data, and service data relates to a plurality of services provided to a plurality of customers by a service provider over a network infrastructure, wherein a virtualization platform is used to present the customer data, network data, and service data from the disparate data sources in a common logical view;
b) processing the customer data, network data, and service data in an analytics platform using a service advisor algorithm to form conclusions and predictions regarding management of customer churn, wherein the service advisor algorithm is also used to generate advice for the service provider based at least in part on the customer data, network data, service data, conclusions, and predictions; and
c) formulating results from the processing to enable the service provider to consider select aspects of the customer data, network data, service data, conclusions, predictions, and advice in relation to reduction of customer churn.

15. The method set forth in claim 14, further comprising:
d) processing the customer data, network data, and service data in the analytics platform using the service advisor algorithm to form conclusions and predictions regarding personalization of service provided to customers; and
e) formulating results from the processing to enable the service provider to consider select aspects of the customer data, network data, service data, conclusions, predictions, and advice in relation to taking further action regarding improvement of personalized services.

16. The method set forth in claim 14, further comprising:
d) processing the customer data, network data, and service data in the analytics platform using the service advisor algorithm to form conclusions and predictions regarding targeted marketing of services to customers or non-customers; and
e) formulating results from the processing to enable the service provider to consider select aspects of the customer data, network data, service data, conclusions, predictions, and advice in relation to taking further action regarding improvement of targeted marketing.

17. The method set forth in claim 14, further comprising:
d) processing the customer data, network data, and service data in the analytics platform using the service advisor algorithm to form conclusions and predictions regarding management of the network infrastructure; and
e) formulating results from the processing to enable the service provider to consider select aspects of the customer data, network data, service data, conclusions, predictions, and advice in relation to taking further action regarding improvement of network infrastructure capabilities.

18. An apparatus for providing advice to a service provider, comprising:
a virtualization platform for accessing customer data, network data, and service data stored in a plurality of disparate data sources, wherein the customer data, network data, and service data relates to a plurality of services provided to a plurality of customers by a service provider over a network infrastructure, wherein the virtualization platform is also for presenting the customer data, network data, and service data from the disparate data sources in a common logical view; and
an analytics platform in operative communication with the virtualization platform for processing the customer data, network data, and service data using a service advisor algorithm to form conclusions and predictions regarding personalization of service provided to customers, management of customer churn, targeted marketing of services to customers or non-customers, and management of the network infrastructure, wherein the service advisor algorithm is also used to generate advice for the service provider based at least in part on the customer data, network data, service data, conclusions, and predictions;
wherein the analytics platform is also for formulating results from the processing to enable the service provider to consider select aspects of the customer data, network data, service data, conclusions, predictions, and advice in relation to taking further action regarding improvement of personalized services, reduction of customer churn, improvement of targeted marketing, or improvement of network infrastructure capabilities.

19. The apparatus set forth in claim 18, further comprising:
an input device in operative communication with the analytics platform and accessible to the service provider for receiving a request for advice relating to at least one of improvement of personalized services, reduction of customer churn, improvement of targeted marketing, and improvement of network infrastructure capabilities;
wherein the accessing by the virtualization platform, the processing by the analytics platform, and the formulating by the analytics platform are tailored at least in part to the request.

20. The apparatus set forth in claim 18, further comprising:
an output device in operative communication with the analytics platform for receiving the formulated results, wherein the output device is accessible to the service provider for review of the formulated results in relation to taking further action regarding at least one of improvement of personalized services, reduction of customer churn, improvement of targeted marketing, and improvement of network infrastructure capabilities.
